(19) United States
(12) Patent Application Publication
(10) Pub. No.: US 2026/0300784 A1
(43) Pub. Date: Oct. 1, 2026

(54) ADAPTIVE PLANNING USING LLMS

(71) Applicants: ORACLE INTERNATIONAL CORPORATION, Redwood Shores, CA (US); ORACLE FINANCIAL SERVICES SOFTWARE LIMITED, Mumbai (IN)

(72) Inventors: Charbel CHUCRI, Ecublens (CH); Soo Min LEE, Zurich (CH); Hesam FATHI MOGHADAM, Sunnyvale, CA (US); Rhicheek PATRA, Zurich (CH); Cosimo FEDELI, Bologna (IT); Govind GOPINATHAN NAIR, Jersey City, NJ (US); Jason Paul SOMRAK, North Royalton, OH (US)

(21) Appl. No.: 19/450,682

(22) Filed: Jan. 15, 2026

Related U.S. Application Data
(60) Provisional application No. 63/778,072, filed on Mar. 26, 2025.

(51) Int. Cl. G06N 5/046; G06F 16/332; G06F 16/3329; G06N 5/022

(52) U.S. Cl. CPC G06N 5/046; G06F 16/3325; G06F 16/33295; G06N 5/022

(57) ABSTRACT

Systems, methods, and other embodiments associated with adaptive planning using LLMs are described. In one embodiment, a method includes receiving a digital representation of a question expressed in natural language for resolution by a large language model. The method includes acquiring digital information that is relevant to answering the question and absent from a digital context associated with the question. The method includes determining that a gap exists in the acquired information based on assessment by the large language model of whether the acquired information is sufficient to answer the question. The method generates a sub-question based on detecting divergent dimensions among the embeddings, wherein the sub-question is formulated to request information that fills the gap in the acquired information. And the method includes recursively executing the computer-implemented method with the sub-question in place of the question until the gap in the acquired information is eliminated.

### CROSS REFERENCE TO RELATED APPLICATIONS

This disclosure claims the benefit of U.S. Provisional Patent Application Ser. No. 63/778,072 filed Mar. 26, 2025, titled “ADAPTIVE PLANNING USING LLMS,” having inventors: Charbel CHUCRI, Soo Min LEE; Hesam FATHI MOGHADAM, Rhicheek PATRA, Cosimo FEDELI, Govind GOPINATHAN NAIR, and Jason Paul SOMRAK, and assigned to the present assignees, the entirety of which is incorporated by reference herein in its entirety.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Large language models (LLMs) generate natural-language responses to complex questions but exhibit technical limitations that reduce efficiency, stability, and accuracy during inference. Conventional systems lack mechanisms to detect when contextual information is incomplete, causing divergent or inconsistent answers and unnecessary computation. Fixed-step reasoning pipelines execute without regard to information sufficiency, leading to excessive token use and unpredictable latency. Retrieval-augmented generation (RAG) techniques statically acquire supporting documents before inference and cannot adjust retrieval scope when reasoning gaps arise, limiting adaptability and wasting resources. Existing iterative and tree-based planners expand reasoning paths indiscriminately, increasing computational cost and memory usage without guaranteeing convergence. These systems also lack quantitative criteria for determining information sufficiency among model outputs, preventing reliable detection of completion conditions. Prior frameworks further fail to integrate textual and numerical reasoning within a unified control loop and often accumulate redundant contextual data without bounding recursion depth or storage growth.

Accordingly, there remains a need for systems and methods that improve LLM operation by dynamically identifying information gaps, adaptively acquiring missing data, and terminating reasoning through quantitative convergence analysis to enhance accuracy, efficiency, and determinism.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a system that is associated with adaptive planning using LLMs.

FIG. 2 illustrates one embodiment of a method that is associated with adaptive planning using LLMs.

FIG. 3 illustrates another embodiment of a method that is associated with adaptive planning using LLMs.

FIG. 4 illustrates a diagram of an example of adaptive planning analysis that is associated with adaptive planning using LLMs.

FIG. 5 illustrates one embodiment of a method that is associated with adaptive planning using LLMs.

FIG. 6 illustrates a diagram of an example of adaptive planning analysis that is associated with adaptive planning using LLMs.

FIG. 7 illustrates result graphs of benchmarking tests of an example adaptive planning system.

FIG. 8 illustrates a diagram of one end-to-end example of adaptive planning analysis that is associated with adaptive planning using LLMs.

FIG. 9 illustrates an embodiment of a computing system configured with the example systems and/or methods disclosed.

### DETAILED DESCRIPTION

Systems, methods, and other embodiments are described herein that provide adaptive planning using large language models (LLMs). In one embodiment, an adaptive planning system answers complex questions by generating a plan step-by-step, using information from prior steps to guide the next ones. For example, the adaptive planning system decomposes complex queries into simpler sub-questions which it answers recursively before revisiting the main question. Additionally, the adaptive planning system adapts to the complexity of the query by stopping the execution once sufficient information has been gathered.

The adaptive planning system focuses on resolving knowledge-intensive tasks that involve answering complex questions by leveraging multiple documents and tools, such as retrieval algorithms or equation evaluation tools for arithmetic operations. These tasks employ multiple reasoning steps that involve querying various data sources and/or the outputs of different tools to derive the correct answer. Moreover, the adaptive planning system exploits the inherent reasoning capabilities of foundational LLMs, avoiding the need for costly fine-tuning.

In one embodiment, the adaptive planning system adaptively controls reasoning depth and width based on missing information, ensuring that inference is bounded by the need to acquire additional information. Quantitative convergence thresholds provide deterministic termination, and bounded hyperparameters limit recursion to maintain predictable computational complexity. By integrating context management, similarity evaluation, and sub-question generation within a unified control loop, the adaptive planning system improves both accuracy and efficiency of the reasoning process that relies on otherwise unmanaged large-language-model inference. The system reduces redundant token processing, minimizes unnecessary retrieval operations, and enhances factual consistency of generated outputs. Accordingly, in one embodiment, the adaptive planning system provides a technical improvement in computer-implemented reasoning systems that drives orchestration of LLM reasoning using a simple yes/no evaluation of information completeness and adaptive context supplementation as control feedback.

No action or function described or claimed herein is performed by the human mind. An interpretation that any action or function described herein can be performed in the human mind is inconsistent with and contrary to this disclosure.

### Example Adaptive Planning System

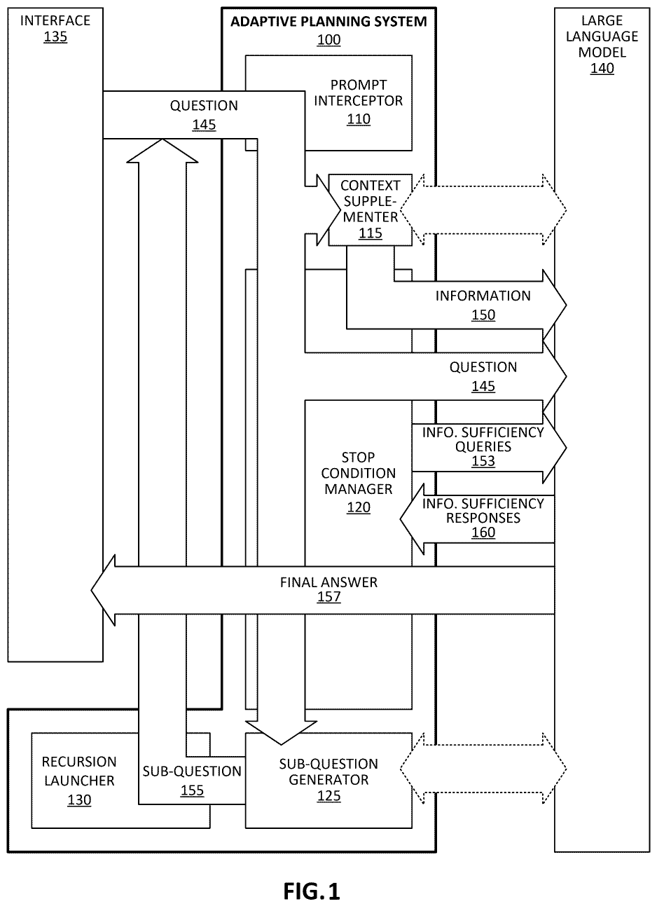

FIG. 1 illustrates one embodiment of an adaptive planning system 100 that is associated with adaptive planning using LLMs. In one embodiment, adaptive planning system 100 improves accuracy and efficiency of reasoning by the large language model by adaptively identifying and filling gaps in the acquired information. Adaptive planning system 100 has various components, including a prompt interceptor 110, a context supplementer 115, a stop condition manager 120, a sub-question generator 125, and a recursion launcher 130. In one embodiment, the components of adaptive planning system 100 intercommunicates via an interface 135 to a large language model 140 in a network computing system, for example by electronic messages, as discussed below under the heading “Cloud or Enterprise Embodiments.” The components of adaptive planning system 100 are configured to produce information that they generate as outputs. The outputs are made available for downstream processing by one or more other components of adaptive planning system 100. In one embodiment, adaptive planning system 100 processes digital data in a pipeline sequence, where each component outputs structured data consumed by a downstream component, thereby forming a closed-loop control architecture for controlling LLM reasoning.

In one embodiment, prompt interceptor 110 is configured to intercept a digital representation of a question 145 expressed in natural language presented through interface 135 for resolution by a large language model (LLM) 140. As used herein, the term “resolution” refers to inference-phase operation by the LLM of mapping an input token sequence (e.g., question 145) to an output token sequence (a response, solution, or other “answer” to the input question). In one embodiment, the question 145 is represented digitally as a text string. The text string of the question 145 may be packaged into a JSON payload, and delivered to an API gateway of LLM 140.

In one embodiment, prompt interceptor 110 is implemented in an API gateway (or other input handling layer) for LLM 140. While the API gateway would ordinarily pass the question 145 into LLM 140 for inference operations to resolve the question 145, prompt interceptor 110 is configured to capture the question 145 before provision to the LLM 140 and place the question 145 into an adaptive planning workflow. For example, the prompt interceptor 110 redirects the question 145 away from LLM 140 and into context supplementer 115 and stop condition manager 120. Intercepting the prompt and diverting it into the adaptive planning workflow improves operation of the LLM 140 by increasing accuracy (with reference to ground truth) and efficiency (with reference to tokens processed to generate the final answer) over other techniques.

In one embodiment, prompt interceptor 110 is configured to selectively redirect complex inputs into the adaptive planning workflow, and let simpler requests proceed to the LLM 140 and bypass the adaptive planning workflow.

Where an incoming prompt satisfies a pre-defined complexity threshold, prompt interceptor 110 reroutes the question 145 to adaptive planning.

In one embodiment, context supplementer 115 is configured to acquire digital information 150 that is both (a) relevant to answering the question 145 and (b) absent from a digital context associated with the natural language question. As used herein, information is “absent” where it either is not express, or is ambiguous, although the absent information may be implicit in the context or question. In one embodiment, information that is “relevant to” answering the question is needed to answer the question without ambiguity, and without which there is a gap in the information.

In one embodiment, context supplementer 115 includes sub-components or modules that execute a pre-determined maximum number of information acquisition actions. In one embodiment, the acquisition actions may be retrieval actions and/or math actions. Additional types of acquisition actions may also be included. The maximum number is an adjustable hyperparameter controlling computational cost. In one embodiment, discrete maximum numbers may be applied to each type of acquisition action such that the individual types are independently limited in frequency or count, permitting separate control of the number of retrieval actions and the number of math actions performed during context supplementation. In one embodiment, one maximum number applies collectively to all types of acquisition actions such that the collective count of all types of actions are kept within the maximum.

In one embodiment, context supplementer 115 includes a retrieval action module. The retrieval action module is configured to generate retrieval queries using LLM 140 or an embedding-based search engine, transmits the queries to a document corpus or vector store, receives document text segments containing information relevant to the question 145. Retrieval action module may further or summarize the text segments (e.g., using LLM 140). Thus, the retrieval action module is configured to extract content from a document to acquire the information 150. As used herein, a “document corpus” refers to refers to a digitally stored collection of text documents, records, or data segments maintained in a searchable electronic repository. Documents within the corpus may be stored as unstructured text, structured data, or a vector representation derived from text embeddings.

In one embodiment, context supplementer 115 includes a math action module. The math action module generates, populates, and evaluates equations that are relevant to the question 145 to obtain numerical information. For example, the math action module is configured to generate an equation template relevant to the question using the large language model. The math action module is configured to populate the equation template by inserting variable values extracted from retrieved contextual information. And, the math action module is configured to solve the completed equation using a numerical interpreter to produce—as information 150—a quantitative result. Thus, the retrieval action module is configured to evaluate an equation to acquire the information 150.

Both modules of context supplementer 115 write their respective output information 150 to a context buffer. The context buffer stores retrieved text, computed results, and corresponding embeddings for use in subsequent reasoning steps. The context buffer stores this information 150 cumulatively over the course of recursive iterations for resolving the question. In this manner, context supplementer 115 expands the digital context supplied to the adaptive-planning workflow by performing a limited number of automated retrieval and computation operations prior to further analysis by LLM 140. This is an improvement over existing techniques that supply static or single-pass context to a LLM without adaptively augmenting the context through iterative retrieval or computation, thereby limiting the reasoning accuracy and depth of analysis for the LLM.

In one embodiment, stop condition manager 120 is configured to determine that a gap exists in the acquired information 150 based on LLM 140 assessment of whether the acquired information 150 is sufficient to answer the question 145. Stop condition manager 120 analyzes information sufficiency response(s) 160 by the LLM 140 to an information sufficiency query 153 to assess whether the acquired information 150 is sufficient to answer the question. The information sufficiency query 153 is configured to cause the LLM 140 to analyze whether the question 145 can be answered completely using the information 150 that is available thus far. In one embodiment, stop condition manager 120 is configured to make a plurality of information sufficiency queries 153 to the LLM 140. The plurality of information sufficiency responses 160 to these queries 153 are generated by the LLM 140 based on the cumulative information 150 acquired by context supplementer 115. Stop condition manager 120 detects that the similarity metrics satisfy a threshold for information sufficiency.

In one embodiment, stop condition manager 120 is configured to choose between (a) providing a final answer 157 to interface 135, or (b) proceeding to a further level of recursion to acquire more information. Stop condition manager 120 makes this choice based on whether a stop condition is satisfied or not. The stop condition is a determination that there is enough information available to provide a full or complete answer to the current question. In one embodiment, the stop condition is satisfied where answers to multiple information sufficiency queries to LLM 140 are unanimously affirmative. Where the stop condition is satisfied, stop condition manager 120 prompts the LLM 140 to answer the question 145, and returns the response of the LLM 140 as the final answer 157 to the question 145.

The information sufficiency queries ask the LLM 140 to determine whether there is enough information to fully answer the current question (or sub-question). For example, at each recursion level, stop condition manager 120 prompts LLM 140 with the information sufficiency query. The query is evaluated by LLM 140 a plurality of times (for example, twice) independently, using the available context. In one embodiment, the inquiry specifies that the LLM is to answer “Yes” or “No” (or other binary values) to the question of whether there is sufficient information.

Thus, in one embodiment, the query prompt to the LLM 140 includes (1) the current question (or sub question), (2) a reference (such as a pointer) to the collected context thus far (or the collected context itself); (3) an instruction to determine whether the context provides sufficient information to answer the question; and (4) an instruction to answer “yes” or “no” (or other binary response) only.

The responses to these queries are information sufficiency responses (rather than attempts to generate full natural-language answers). Each information sufficiency response is evaluated to determine whether it indicates that adequate information is available. The stop condition manager 120 captures the information sufficiency response from each evaluation of the information sufficiency query at the current level of recursion. The stop condition manager parses each information sufficiency response to determine whether or not the response is “Yes.” Thus, the information-sufficiency responses represent evaluations by the LLM of whether adequate information has been gathered to fully answer the question or sub-question under consideration, rather than direct attempts to answer the question itself.

Once all (e.g., both) information sufficiency responses affirm that there is enough information to answer the current question (or sub-question), the recursion-control module terminates the adaptive-planning process and directs LLM 140 to produce a single final answer 157. Put simply, if all information sufficiency responses are “Yes,” the stop condition manager 120 proceeds to prompt the LLM 140 to answer the current question (or sub-question). The resulting final answer 157 is transmitted to interface 135 for presentation to the user or for downstream consumption by client systems.

If, instead, any one or more of the information sufficiency responses indicate that there is not enough information to answer the current question/sub-question (a “No” response), the stop condition manager 120 proceeds to sub question generator 125 launch a further level of recursion using a further sub-question.

Instead of a fixed number of reasoning steps or a user-defined “end-of-chain,” in one embodiment stop condition manager 120 is configured to autonomously terminate recursion of the adaptive-planning workflow dynamically upon confirmation of convergence on information completeness. This is a quantitative analysis that provides a measurable, content-agnostic control signal. In this way, stop condition manager 120 implements a feedback loop that halts LLM reasoning adaptively when sufficient information convergence is detected. This quantitative feedback control is an improvement over prior iterative or tree-based reasoning methods (such as Tree of Thoughts), which expand reasoning paths regardless of information convergence, and over reasoning methods that rely on a fixed iteration count.

In one embodiment, sub-question generator 125 is configured to generate a sub-question 155 in natural language that is formulated to request information that fills the gap in the acquired information. In one embodiment, sub-question generator 125 includes a gap-analysis module, a prompt-construction module, and a language-generation module.

The gap analysis module of sub-question generator 125 identifies missing or uncertain information by prompting an LLM 140 to identify what information is missing from the context or uncertain in the context that is needed to answer the question 145. (For convenience, the missing or uncertain information may be referred to herein simply as “missing” information). For example, the prompt construction module of sub-question generator 125 assembles a gap identification prompt that includes the current question 145, the current digital context, and an instruction to state the information needed to answer the question 145 that is missing from the current question 145 and current digital context. The language generation module of sub-question generator 125 submits the assembled gap identification prompt to LLM 140 to cause the LLM 140 to state in a response the information that is missing. The language generation module parses the response to capture a description of the missing information.

The prompt-construction module then assembles a generation prompt that includes the current question, the current digital context, and an instruction to produce a simpler question that requests the missing information captured from the response to the gap-identification prompt. The language-generation module submits the assembled generation prompt to LLM 140 to generate the text of the sub-question 155 and returns the resulting digital representation of the sub-question 155 for recursive execution in the adaptive-planning workflow.

In one embodiment, recursion launcher 130 is configured to recursively execute the adaptive planning workflow with the sub-question 155 in place of the question 145 until the gap in the acquired information 150 is eliminated. Recursion launcher 130 transmits the sub-question 155 to the API gateway of LLM 140. Recursion launcher 130 also transfers accumulated contextual data, including acquired information (retrieved or computed) and embeddings, to preserve reasoning continuity. In one embodiment, recursion launcher 130 may include in its transmission a routing flag, metadata tag, or API parameter directing that the sub-question 155 be handled by adaptive planning rather than standard inference by the LLM 140.

In one embodiment, adaptive planning system 100 is executed by one or more processors of a computing platform that communicates with large language model 140 via network interface 135. In one embodiment, the adaptive planning system 100 may initialize upon detection of any trigger condition described herein and may terminate automatically upon satisfaction of the stopping condition, outputting the final answer 157 for presentation or downstream machine consumption.

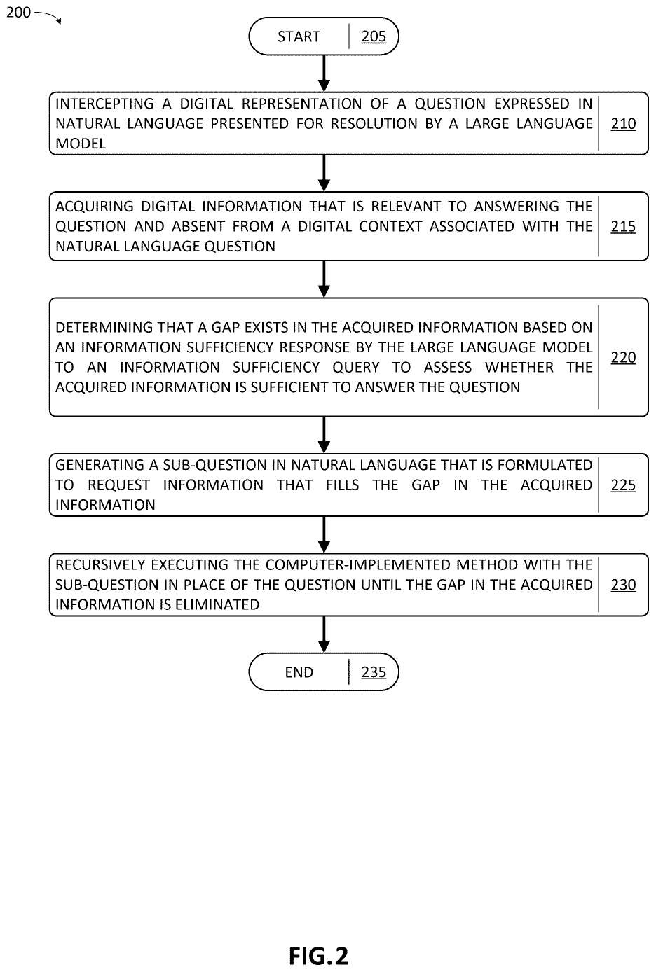

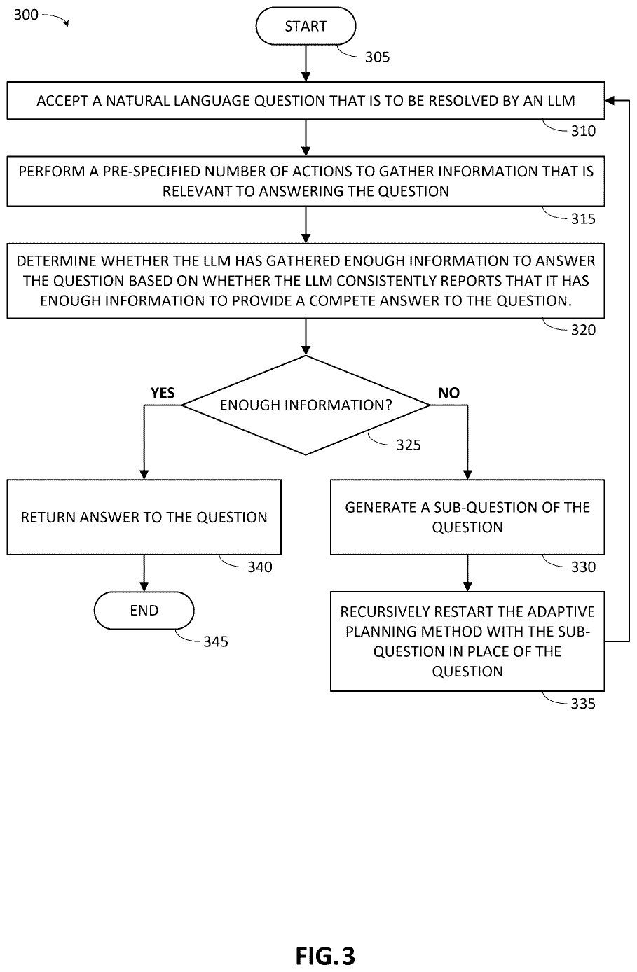

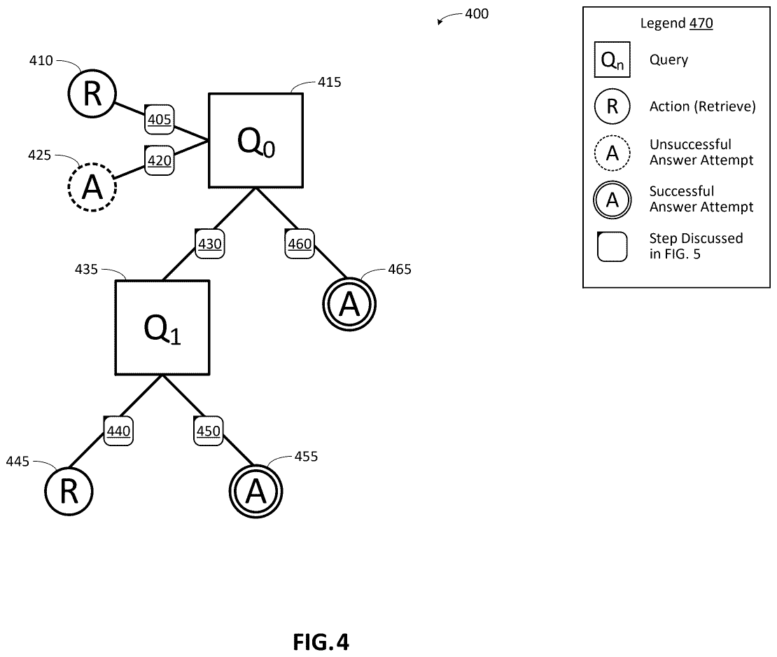

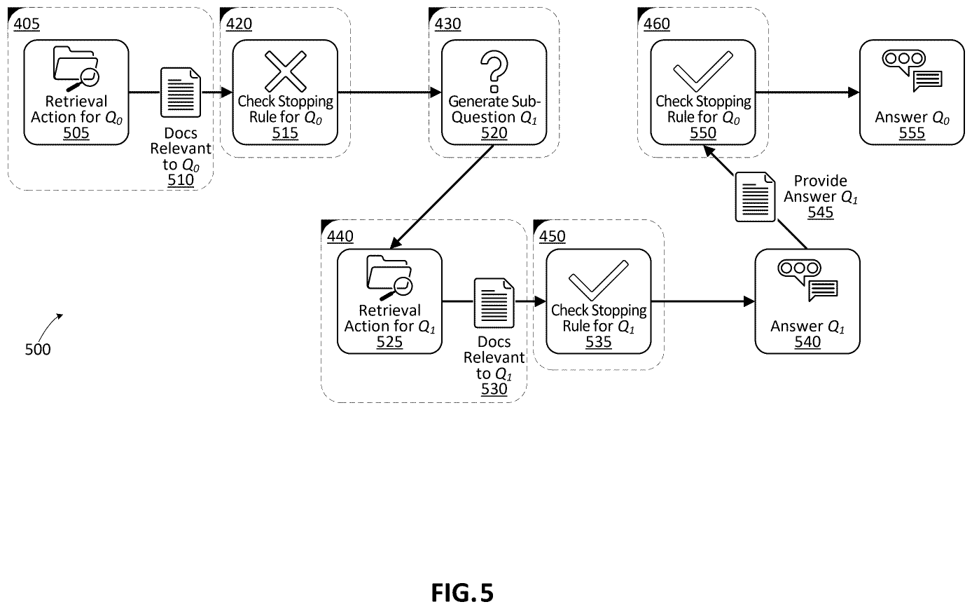

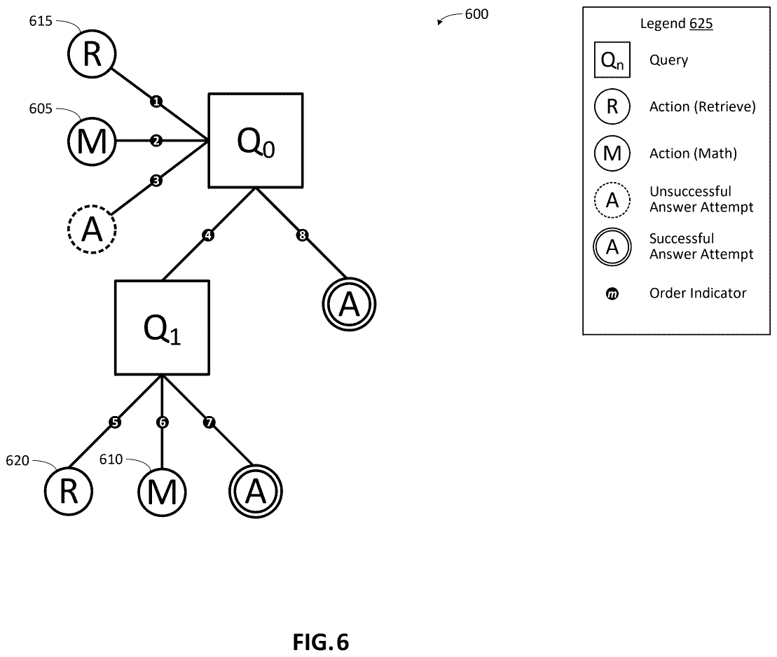

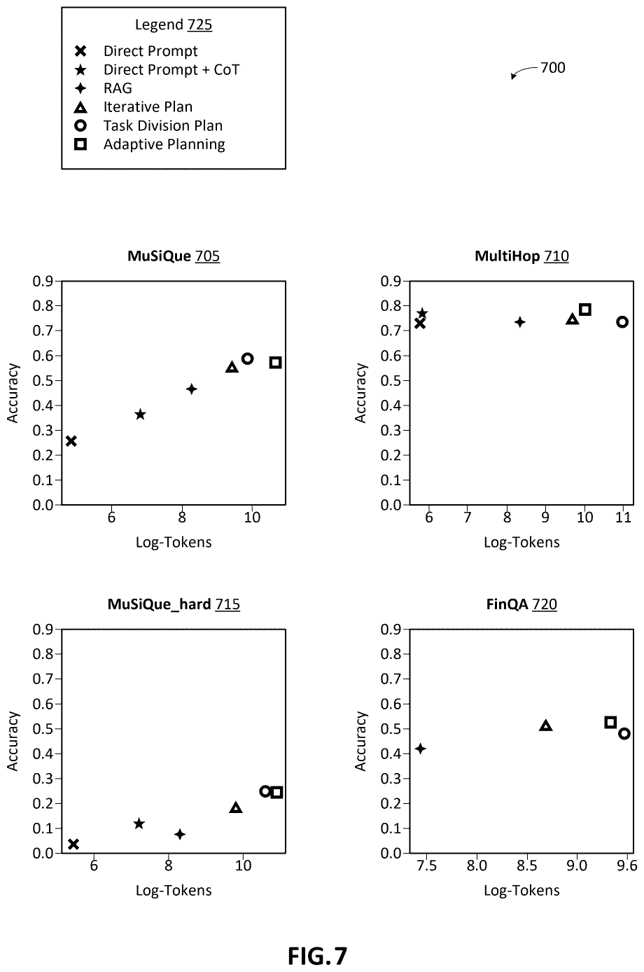

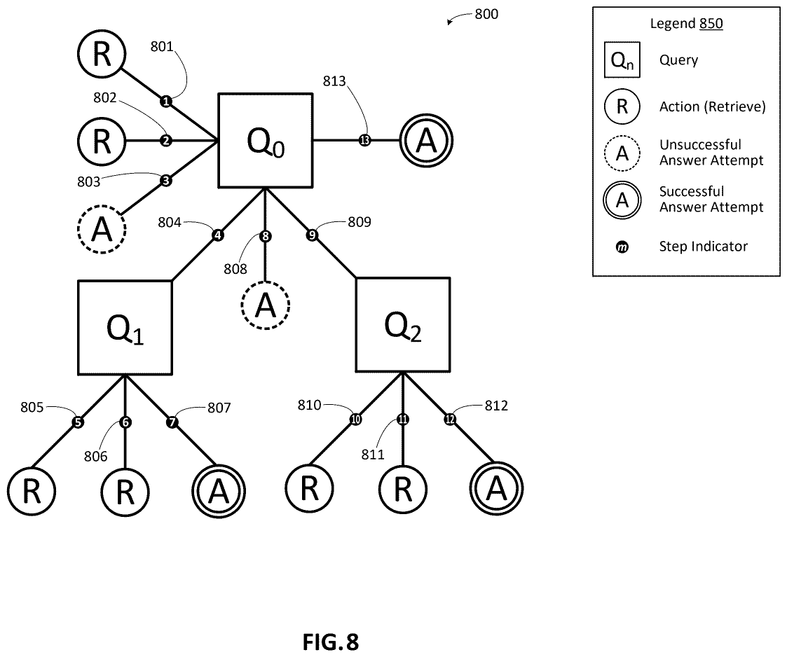

Further details regarding adaptive planning system 100 are presented herein. In one embodiment, operations of adaptive planning system 100 will be described with reference to adaptive planning method 200 of FIG. 2. In one embodiment, operations of adaptive planning system 100 will be described with reference to adaptive planning method 300 of FIG. 3. In one embodiment, one example adaptive planning analysis 400 using retrieval actions to acquire information relevant to answering the question will be shown as both a recursion tree diagram in FIG. 4 and a sequence of steps in FIG. 5. In one embodiment, another example adaptive planning analysis with math 600—that is, using math actions to acquire information relevant to answering the question—will be described with reference to a recursion tree of FIG. 6. In one embodiment, benchmarking tests demonstrating the performance improvement over prior techniques that is provided by adaptive planning system 100 will be described with reference to result graphs 700 of FIG. 7. In one embodiment, a further example adaptive planning analysis will be described with reference to Table 4 and recursion tree 800 of FIG. 8.

### Example Adaptive Planning Method

FIG. 2 illustrates one embodiment of an adaptive planning method 200 that is associated with adaptive planning using LLMs. In one embodiment, as a general overview, adaptive planning method 200 receives a natural language question intended for resolution by a large language model. Adaptive planning method 200 gathers missing digital information needed to answer the question. Adaptive planning method 200 detects whether an information gap remains after gathering the missing information by asking the LLM whether it has enough information to provide a complete answer to the question posed (at the current level of recursion). If so, adaptive planning method returns the final answer by the LLM to the question. If not, adaptive planning method 200 then forms a simpler sub-question targeting the missing information and recursively repeats the process with the sub-question until the gap in the information is resolved.

In one embodiment, adaptive planning method 200 initiates at START block 205 in response to adaptive planning system 100 determining that one or more conditions or events have been detected or have occurred. The conditions or events for initiating adaptive planning method 200, include, but are not limited to: (1) adaptive planning system 100 has received an instruction to use adaptive planning to manage answering of a question by an LLM; (2) adaptive planning system 100 has received a question directed to the LLM; (3) adaptive planning system 100 has detected that a received natural-language question exceeds a predefined complexity threshold; (4) adaptive planning system 100 has recursively launched the adaptive planning method 200 from within a pending instance of adaptive planning method 200; (5) adaptive planning system 100 has detected that a direct inference attempt by the LLM has failed to produce a consistent or complete answer; (6) adaptive planning system 100 has detected that a prompt is accompanied by a routing flag, metadata tag, or API parameter directing that the question be handled by adaptive planning; (7) a user or administrator has initiated adaptive planning method 200; (8) it is currently a time at which adaptive planning method 200 is scheduled to be run; or (9) some other condition for commencing adaptive planning method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of adaptive planning system 100 executes adaptive planning method 200. In one embodiment, at START block 205, adaptive planning system 100 configures compute resources for performing adaptive planning method 200. (1) Adaptive planning system 100 provisions (i.e., allocates and initializes) resources of the computing system that are used by adaptive planning system 100, such as processor, memory and storage (for example, for executing components of adaptive planning system 100). (2) Adaptive planning system 100 establishes access to one or more networks for the resources, such as access to (a) internal networks for communication among components of adaptive planning system 100 and (b) external networks for communication with other computing systems (for example, client systems, interface 135, and/or large language model 140). (3) Adaptive planning system 100 connects to data sources (such as databases, data stores, file systems, and cloud storage) used by the adaptive planning method 200. And, (4) Adaptive planning system 100 configures the computing system with system settings, software dependencies and libraries, and modules for executing the components of adaptive planning system 100. Following initiation at START block 205, adaptive planning method 200 proceeds to block 210.

At block 210, adaptive planning method 200 intercepts a digital representation of a question expressed in natural language presented for resolution by a large language model. In one embodiment, the adaptive planning system 100 captures a natural-language input before it is processed by the large language model 140, redirecting it into the adaptive-planning workflow. In one embodiment, the digital representation may be a UTF-8-encoded text string or token sequence received through an application programming interface or web service endpoint.

In one embodiment, adaptive planning method 200 performs this step through prompt interceptor 110, which operates within an input-handling layer or API gateway that ordinarily forwards prompts directly to the large language model. Instead of passing the prompt through to the LLM 140 unchanged, prompt interceptor 110 detects inbound payloads corresponding to user queries and diverts them to context supplementer 115 and stop condition manager 120 for adaptive processing. The prompt interceptor 110 forwards the prompt to the adaptive-planning workflow.

In one embodiment, adaptive planning method 200 intercepts a digital representation of a question expressed in natural language presented for resolution by a large language model as follows. Adaptive planning method 200 monitors inbound prompt payloads to the API gateway. Adaptive planning method 200 routes the intercepted prompt into the adaptive planning workflow, e.g. starting at context supplementer 115. Adaptive planning method 200 stores a copy of the prompt in temporary memory for downstream modules. The subsequent steps will proceed to have the LLM answer the question as soon as the adaptive planning method 200 determines that there is enough information to answer the question.

In one embodiment, the steps of block 210 are performed by prompt interceptor 110. At the conclusion of block 210, adaptive planning method 200 has converted a raw user prompt into a normalized and classified input object, configured for adaptive reasoning. Processing continues to block 215.

At block 215, adaptive planning method 200 acquires digital information that is relevant to answering the question and absent from a digital context associated with the natural language question. In one embodiment, adaptive planning method 200 supplements the existing context by querying digital repositories or executing computations to produce information that contributes to resolving the question.

In one embodiment, adaptive planning system 100 performs this step through context supplementer 115, which supplements incomplete contextual information before the large language model 140 attempts resolution. The computing system analyzes the stored context buffer to identify where information is missing. In one embodiment, context supplementer 115 detects absence by asking LLM 140 to state the missing information that is needed to answer the question and is unavailable from the context. In one embodiment, context supplementer 115 further asks LLM 140 to designate one or more types of acquisition action (e.g., retrieve from datastore or perform math) that will acquire the missing information (at least in part). Context supplementer 115 captures the responses of the LLM 140 that identify the missing information and (in one embodiment) the designated type(s) of acquisition actions to perform to obtain the missing information. Context supplementer 115 then executes one or more acquisition actions to obtain the missing information. Acquisition actions may include retrieval operations from a document corpus or computational operations that produce numeric data relevant to the question.

Context supplementer 115 dynamically selects which acquisition actions to perform based on a configurable hyperparameter defining the maximum number of actions permitted. The supplementer includes a retrieval action module and a math action module, each capable of independently acquiring information 150. The retrieval action module formulates retrieval queries using either LLM 140 or an embedding-based search engine, transmits the queries to a document corpus or vector store, and receives document segments containing potentially relevant information. The segments may optionally be summarized by the model to condense the results to contextually pertinent content. Relevance might be computed through vector similarity using cosine similarity, Euclidean distance, or Manhattan distance metrics applied to the vector embeddings of the missing information and the document segments. The math action module uses the LLM 140 to generate an equation template relevant to the question, populates variables using retrieved data, and computes a quantitative result using a numerical interpreter, such as a Python or Java-based arithmetic engine. Each computed or retrieved result is serialized as digital information 150 and stored for downstream use.

In one embodiment, adaptive planning method 200 acquires digital information that is relevant to answering the question and absent from a digital context associated with the natural language question as follows. Adaptive planning method 200 analyzes embeddings of the question and current context buffer. Adaptive planning method 200 detects missing or low-similarity dimensions signifying absent information. Adaptive planning method 200 selects a retrieval or math action according to a type of information that is missing: absent semantic information triggers a retrieval action, and absent quantitative results triggers a math action. In one embodiment, the LLM 140 is used to select between the retrieval action and the math action, for example in response to a prompt that instructs the LLM 140 to indicate which of the available types of action will best supply the missing information. The LLM 140 then returns a selection of either the retrieval action or the math action.

To perform a retrieval action: adaptive planning method 200 formulates and transmits a query for execution, receives document segments, and summarizes relevant content. To perform a math action: adaptive planning method 200 generates and populates an equation, then computes a result using a numerical interpreter. Adaptive planning method 200 writes each retrieved or computed output 150, with corresponding embeddings, to the context buffer. Adaptive planning method 200 repeats this information acquisition process until the number of actions reaches the pre-defined hyperparameter limit or until no further items of information are absent, whichever is least.

In one embodiment, the steps of block 215 are performed by context supplementer 115. At the conclusion of block 215, adaptive planning method 200 has expanded the digital context by adding newly retrieved or computed information 150 and corresponding embeddings. This augmentation of the context enables more accurate and efficient reasoning in subsequent steps, reducing the use of sub-questions to missing information that is not provided by the acquisition actions. Processing continues to block 220.

At block 220, adaptive planning method 200 determines that a gap exists in the acquired information based on an information sufficiency response by the large language model to an information sufficiency query to assess whether the acquired information is sufficient to answer the question. In one embodiment, adaptive planning method 200 detects an information gap when the LLM does not consistently indicate that the cumulative information gathered by the adaptive planning system is enough to fully answer the question posed at the current level of recursion. Lack of unanimous responses to queries to the LLM as to whether the information is sufficient to signify that the available information does not allow the LLM to accurately resolve the question. In short, adaptive planning method 200 infers that information is missing when one or more of multiple yes or no answers by the LLM to an information sufficiency query such as “is there enough information to answer [Current_Question]” is “no.”

In one embodiment, stop condition manager 120 performs this operation by analyzing the consistency of several (at least two) independent answers produced by the large language model 140 when resolving the same information sufficiency query using the acquired information 150. Unanimous, independent “yes” responses to the information sufficiency query indicates that the cumulative context information developed by the adaptive planning system (as of the current level of recursion) enables the LLM to produce an unambiguous, complete response to the current question (as of the current level of recursion). Lack of unanimous “yes” responses, such as one or more “no” responses indicates that the cumulative context information does not allow the LLM to produce a response to the question that is unambiguous or complete, and therefore that there is information missing from the context. In this case, the adaptive planning system detects the absence of information (presence of a gap) automatically and flags a corresponding context segment in the context buffer for supplementation by recursion. The adaptive planning system will then proceed to further levels of recursion to develop the missing information.

In one embodiment, stop condition manager 120 generates an information sufficiency query. For example, the information sufficiency query is a prompt that includes (1) a reference to the cumulative context developed thus far, (2) the current question; and (3) an instruction to the LLM to answer-“yes” or “no”-whether the current question can be answered given the cumulative contextual information. The stop condition manager 120 submits the information sufficiency query to the LLM a plurality of times, causing the LLM to produce a corresponding plurality of “yes” or “no” information sufficiency responses independently from each other. The stop condition manager 120 captures the plurality of independent information sufficiency responses from the LLM. The stop condition manager 120 compares the plurality of information sufficiency responses produced independently by the large language model 140 when given the same question and context to determine whether any one or more of the information sufficiency responses is a “no” response that indicates that the context does not provide enough information to answer the question. In one embodiment, the number of information sufficiency responses compared is a tunable hyperparameter. In one example, a number of information sufficiency responses between 2 and 5 is pre-specified. In an example embodiment, two information sufficiency responses are generated for each evaluation cycle, a minimum check on the LLM's assessment of information sufficiency. Using more than two answers (e.g., three or more) provides additional surety that the contextual information acquired (up to and through the current level of recursion) is sufficient.

In one embodiment, adaptive planning method 200 determines that a gap exists in the acquired information as follows. Adaptive planning method 200 generates a information sufficiency query from the current question and contexts. Adaptive planning method submits the information sufficiency query multiple times to the LLM 140. The LLM 140 independently generates multiple yes or no information sufficiency responses to the information sufficiency query. Adaptive planning method 200 captures the plurality of independent information sufficiency responses 160 from the LLM 140. Adaptive planning method 200 compares the information sufficiency responses 160 to a pre-defined stopping condition. In one embodiment, the stopping condition is satisfied when all information sufficiency responses 160 are “yes.” When any one or more of the information sufficiency responses 160 is “no,” the stopping condition fails, and adaptive planning method 200 flags the current context as containing an information gap. Adaptive planning method 200 stores gap flags in the context data structure for access by sub-question generator 125.

Thus, in one embodiment, adaptive planning method 200 prompts the LLM a plurality of times (e.g., at least two times) to indicate whether there is enough information to answer the question. Where each of the plurality of prompts results in an answer of “yes,” the stopping condition is satisfied, and processing proceeds to return a final answer without entering a further level of recursion with a sub-question. Where one or more of the plurality of prompts results in an answer of “no,” there is a gap in information, and processing proceeds to generate a sub question to close the gap in a further level of recursion.

In one embodiment, the steps of block 220 are performed by stop condition manager 120. At the conclusion of block 220, adaptive planning method 200 has determined whether there is or is not sufficient information to answer the current question. Where there is no gap in the information, the adaptive planning method 200 prompts the LLM 140 to answer the current question 145, and returns the response of the LLM 140 as the final answer 157 to the current question. Where there is a gap in the information, this gap detection provides a basis for generation of new sub-questions targeting the missing information, and processing continues to block 225.

At block 225, adaptive planning method 200 generates a sub-question in natural language. The sub-question is formulated to request information that fills the gap in the acquired information. In one embodiment, the adaptive planning method requests the LLM to generate the sub-question. For example, the LLM is provided with a prompt to the LLM to generate a sub-question that will obtain the information that will fill the gap needed to answer the main question. Adaptive planning method 200 creates a simpler follow-up question that asks for the information missing from earlier, inconsistent answers.

In one embodiment, sub-question generator 125 performs operations to formulate a new question that resolves inconsistencies among prior model-generated answers. Initially, the sub-question generator identifies the information that is missing (or uncertain) in the current context. In one embodiment, the sub-question generator prompts the LLM 140 to identify the information that is missing (or uncertain) in the current context. The prompt includes the current question, the current context, and an instruction to detect what information is needed to answer the question, but which is unavailable given the current context. The sub-question generator 125 then captures the response from the LLM 140, and parses the response to extract the identified missing information. In one embodiment, the response from the LLM 140 may identify several items of missing information. Sub-question generator 125 extracts the plurality of items of missing information from the response.

Sub-question generator 125 conditions a prompt to the LLM 140 that incorporates this identified missing information. As used herein, conditioning a prompt refers to the process of modifying or constructing an input sequence for a large language model to influence the output of the LLM toward a desired goal. Conditioning may include inserting additional contextual data, control tokens, semantic vectors, or instructions that bias the attention and token-generation probabilities of the LLM toward specific topics or relationships. In one embodiment, conditioning a prompt comprises appending or inserting extracted salient terms, retrieved context, or model-generated instructions to the text of a natural-language query so that the large language model interprets the query in light of that supplemental information. Conditioning may include population or modification of a template prompt.

The prompt is configured to elicit the missing information that would fill the gap. In one embodiment, the prompt includes both the original question and an instruction such as: “Generate a sub-question that would elicit information related to [missing information] necessary to reconcile prior inconsistent answers.” LLM 140 executes the conditioned prompt, and outputs a sub-question 155 expressed in natural language. In this way, the sub-question 155 is formulated to request information that fills the identified semantic gap. The sub-question 155 is thus an interpretable query that can be executed recursively in the adaptive planning workflow.

In one embodiment, where several missing items of information have been identified, sub-question generator 125 generates a plurality of prompts to generate missing information that correspond to the plurality of missing items of information. The number of sub-questions that may be generated in a recursion may be capped at a pre-selected maximum (e.g., variable “max_width,” discussed with respect to Table 1 below). The plurality of sub questions are individually executed recursively to obtain their respective missing items of information.

Sub-question generator 125 constructs a prompt to generate the sub-question that is populated with the extracted salient terms or concepts to guide inference by the LLM 140. Sub-question generator 125 submits the prompt to the LLM 140 to cause generation of the sub-question that elicits information corresponding to the missing concepts. Sub-question generator 125 stores the sub-question 155 for subsequent recursive execution.

In one embodiment, the steps of block 225 are performed by sub-question generator 125. At the conclusion of block 225, adaptive planning method 200 has transformed a set of inconsistent model outputs into a targeted sub-question 155 that is explicitly designed to fill the semantic gap in the acquired information. This automated conversion of embedding-space residuals into actionable natural-language prompts enables adaptive, self-directed refinement of the reasoning by the LLM. This improves over prior systems, which could not isolate and request the particular semantic features that were missing from context. Processing continues to block 230.

At block 230, adaptive planning method 200 recursively executes the adaptive planning method 200 with the sub-question in place of the question until the gap in the acquired information is eliminated. The adaptive planning workflow thus repeats, analyzing the generated sub-question to accumulate additional context. Additional new recursion layers are launched to target missing information with progressively finer granularity until information sufficiency is achieved.

In one embodiment, the adaptive planning method 200 may complete multiple recursive cycles, each refining the acquired context with a sub-question derived from prior results. For example, the recursion launcher 130 executes the adaptive planning method 200 at successive recursion levels until semantic convergence is achieved. In each recursion level, filling the gap partially or wholly resolves ambiguity, incompleteness, or inconsistency in the information. As missing information is incorporated into the context buffer, subsequent reasoning by the model yields more consistent and convergent answers.

In one embodiment, the adaptive planning method 200 initiates a new recursion level by transmitting the sub-question to the computational modules—context supplementer 115, stop condition manager 120, sub-question generator 125, and recursion launcher 130—that executed the prior question. Each recursion level inherits the accumulated digital context from preceding levels, including acquired information (e.g., retrieved text, computed results) and/or their corresponding embeddings stored in the context buffer. For some levels of recursion, the accumulated digital context further includes previous answers to sub-questions and/or their corresponding embeddings stored in the context buffer. This inheritance maintains continuity of reasoning across recursion levels.

During the individual recursive instances, the context supplementer 115 performs a limited number of retrieval or math actions to expand the context with information responsive to the sub-question, as discussed above at block 215. The stop condition manager 120 then re-evaluates semantic similarity among new LLM-generated answers to determine whether information convergence has been achieved, as discussed above at block 220. If information insufficiency persists, another sub-question is generated (as discussed at block 225) and processed at a deeper recursion level. If, instead, the answers meet the similarity threshold (or the maximum recursion depth is reached, as discussed below), recursion terminates and the resulting information and answer are propagated upward to the preceding level.

In one embodiment, the recursion launcher 130 coordinates this process by maintaining a recursion-depth counter and enforcing a predefined maximum recursion depth hyperparameter to prevent infinite execution. In one embodiment, the recursion launcher uses a stack data structure to manage pending sub-questions and their associated contexts, ensuring deterministic unwinding when termination conditions are satisfied.

In one embodiment, the recursion depth hyperparameter is pre-determined. In one embodiment, the hyperparameter for maximum recursion depth is between 2 and 4, which balances accuracy gains with latency and token cost. For example, a recursion depth maximum of 3 has been found to be effective in experimentation. In latency sensitive deployments, shallower depths may be appropriate, such as a recursion depth maximum of 2. Where the question is hard, a recursion depth of up to 8 may be appropriate to preclude runaway recursion when responding to questions that are highly complex, adversarial, or noisy, although values above 5 generally provide diminishing returns. Thus, in one embodiment, the maximum recursion depth is configurable between two and five levels, and recursion terminates earlier upon satisfaction of a semantic-consistency threshold.

In one embodiment, adaptive planning method 200 recursively executes the computer-implemented method with the sub-question in place of the question until the gap in the acquired information is eliminated as follows. Adaptive planning method 200 increments the recursion-depth counter, compares the current depth to the pre-specified maximum recursion depth, and either aborts the recursion if maximum recursion depth is exceeded or proceeds to a new recursion level if maximum recursion depth is not exceeded. Adaptive planning method 200 initializes a new recursion level that inherits the current context. Adaptive planning method 200 reads the generated sub-question and passes the sub-question to the new recursion level as current input. Adaptive planning method 200 awaits completion of the new recursion level to return updated context. Upon return of the updated context generated by the new recursion level, adaptive planning method 200 merges the updated context into the current context in the context buffer. Adaptive planning method 200 decrements the recursion depth counter.

In one embodiment, the steps of block 230 are performed by recursion launcher 130. At the conclusion of block 230, adaptive planning method 200 has produced an expanded, semantically complete context and a convergent answer derived through one or more recursive levels of reasoning. Processing continues to end block 235, where adaptive planning method 200 concludes.

Thus, in one embodiment, adaptive planning method 200 automatically (1) identifies gaps in information during LLM reasoning and (2) iteratively supplements missing context through sub-questions that specifically target the missing context, thereby driving the LLM toward a consistent, complete, and verifiable answer.

### Example Additional Features of Adaptive Planning Method

In one embodiment, determining that the gap exists in the acquired information (discussed at block 220) includes determining that the information sufficiency response indicates that information is not sufficient. Here, the information sufficiency response discussed at block 220 is one of a plurality of information sufficiency responses (e.g. two information sufficiency responses), one or more of which responses may indicate that the information is sufficient. The plurality of responses are checked against a threshold condition for information sufficiency: unanimity in determination that there is sufficient information. Thus, a single negative response stating that the information is insufficient is indicative that there is a gap in the information needed to render a complete answer to the pending question at a given level of recursion.

In one embodiment, generating the sub-question (discussed at block 225) further includes assembling a prompt including the question, the digital context, an indication of the missing information that is absent from the context, and an instruction to generate a sub-question that requests the missing information.

In one embodiment, execution of the adaptive planning method 200 is subject to at least one of the following hyperparameters: a maximum recursion depth, a maximum number of sub-questions per recursion level, and a maximum number of information acquisition actions performed before determining whether the gap exists (as discussed at block 220) In one embodiment, the adaptive planning method 200 further includes tuning the at least one of the hyperparameters to maximize answer accuracy for a given token budget using a validation dataset.

In one embodiment, the adaptive planning method 200 may generate several sub-questions in each recursive level, with each of this plurality of sub-questions targeting discrete items of missing information. Accordingly, the generating the sub-question in natural language further comprises generating a plurality of sub-questions up to a pre-set maximum. And, the recursively executing the computer-implemented method with the sub-question in place of the question further includes recursively executing the plurality of sub questions.

In one embodiment, acquiring the digital information (discussed at block 215) further includes prompting the large language model to choose from among a set of actions for acquiring the information. The prompt to choose includes the question and context.

In one embodiment, acquiring the digital information (discussed at block 215) further includes at least one of: (a) extracting the information from a document; or (b) evaluating an equation to generate the information.

In one embodiment, acquiring the digital information (discussed at block 215) further includes steps to obtain and summarize the information. The adaptive planning method 200 generates a retrieval query using the large language model. The adaptive planning method 200 executes the retrieval query to extract text segments from a document corpus. And, the adaptive planning method 200 summarizes the retrieved text segments using the large language model to produce the acquired information.

In one embodiment, the adaptive planning method 200 automatically terminates the recursion upon satisfaction of a threshold for information sufficiency by the plurality of information sufficiency responses generated by the large language model. For example, the adaptive planning method 200 automatically terminates the recursion upon each of a plurality of information sufficiency responses indicating that the information is sufficient to answer the question. Thus, a unanimous “yes” response by the LLM to several information sufficiency queries satisfies the threshold for information sufficiency.

### Discussion of Adaptive Planning Method with Illustrative Examples

FIG. 3 shows another example embodiment of an adaptive planning method 300 associated with adaptive planning using LLMs. Adaptive planning method 300 initiates at START block 305 in response to adaptive planning system determining that one or more conditions or events precedent to commencement of the adaptive planning method 300 have been detected or have occurred (thereby triggering performance of adaptive planning method 300). At block 310 adaptive planning method 300 accepts a question—written in natural language—that is to be resolved by an LLM. At block 315, adaptive planning method 300 takes a pre-specified number of actions to gather information that is relevant to answering the question. At block 320, adaptive planning method 300 determines whether the LLM has gathered enough information to answer the question based on whether the LLM consistently reports that it has sufficient information to provide a complete answer to the question. This determination serves as a stopping rule or base condition for a recursive loop, as shown by decision block 325. At block 330, where it has been determined that there is not enough information to answer the question (320: NO), adaptive planning method 300 generates a sub-question of the question. The sub-question is simpler than the question initially posed. At block 335, adaptive planning method 300 recursively restarts the adaptive planning method 300 (proceeding from block 310) with the sub-question in place of the question. At block 340, where it has been determined that there is enough information to answer the question (320: YES), adaptive planning method 300 prompts the LLM to generate, and then returns, a final answer to the question. The final answer is generated by the LLM given all the information obtained by means of-sub-questions and their answers, and proceeds to end block 345, where adaptive planning method 300 concludes.

The planning algorithm performed by the adaptive planning system answers questions step by step. It begins by executing one or more actions to gather relevant information (the number of actions to execute here is a hyperparameter). Next, it checks a stopping rule to determine if the model has enough information to answer the question. This is done by querying the LLM as to the sufficiency of information multiple times and checking for consistent affirmation by the LLM. If the LLM responds that there isn't enough information one or more times, a simpler sub-question is generated, and the process is repeated recursively on that sub-question (i.e., actions are executed, the stopping rule is checked, and the process either recurses again or proceeds to answer the sub-question). Once the sub-question is resolved, the stopping rule is checked again and so on. When the model has gathered sufficient information, it can answer the main question and stop the program's execution.

FIG. 4 illustrates, in a recursion tree diagram, an example adaptive planning analysis 400 that is associated with adaptive planning using LLMs. FIG. 5 (discussed below) illustrates the example adaptive planning analysis 400 as a sequence of steps 500 that is associated with adaptive planning using LLMs. Note, as used herein, an “answer attempt” refers to a single instance in which the LLM generates a response to a given question under current contextual conditions.

Such a response is considered an attempt because the response is a candidate to be used as a final answer.

In a first step 405, the adaptive planning analysis 400 performs a retrieval action 410 to gather document(s) or other information that is relevant to an initial query 415 Q₀. In a second step 420, initial query 415 Q₀ is presented to an LLM, and the adaptive planning analysis 400 checks a stopping rule for initial query 415 Q₀ by determining if there is enough information for initial query 415 Q₀ to be successfully answered by the LLM. The stopping rule fails, because information needed to answer the initial query 415 Q₀ is missing, rendering the attempt to answer the initial query 415 Q₀ an unsuccessful answer attempt 425.

In a third step 430, the adaptive planning analysis 400 generates a sub-question (or sub-query) 435 Q₁. Sub-question 435 Q₁ is a simpler question that is configured to develop missing information that is relevant to resolving initial query 415 Q₀. In a fourth step 440, the adaptive planning analysis 400 performs a retrieval action 445 to gather document(s) or other information that is relevant to sub-question 435 Q₁. In a fifth step 450, sub-question 435 Q₁ is presented to the LLM, and the adaptive planning analysis 400 checks the stopping rule for sub-question 435 Q₁ by determining whether there is enough information for sub-question 435 Q₁ to be successfully answered. The stopping rule succeeds, because the retrieval action 445 has obtained information needed to answer the sub-question 435 Q₁, rendering the attempt to answer the sub-question 435 Q₁ a successful answer attempt 455. The adaptive planning analysis records the successful answer to sub-question 435 Q₁ as further context.

Thus supplied with additional context information—the information developed by retrieval action 445 that is relevant to sub-question 435 Q₁, and the answer to sub-question 435 Q₁—the adaptive planning analysis 400 returns to analysis of initial query 415 Q₀. In a sixth step 460, initial query 415 Q₀ is again presented to the LLM, and the adaptive planning analysis 400 checks the stopping rule for initial query 415 Q₀ by determining again whether there is enough information for the initial query 415 Q₀ to be successfully answered by the LLM. Due to the additional context information developed by retrieval action 445 and answer to sub-question 435 Q₁, the stopping rule succeeds, rendering the attempt to answer the initial query 415 Q₀ now a successful answer attempt 465.

By recursively breaking down complex tasks into simpler ones, the adaptive planning algorithm improves the accuracy of the LLM. This recursive structure enables the LLM to solve complex questions that would otherwise be too difficult.

Referring now to FIG. 5, FIG. 5 illustrates the example adaptive planning analysis 400 as a sequence of steps 500 that is associated with adaptive planning using LLMs. As also shown above, the adaptive planning system 100 executes a retrieval action 505 for the initial query Q₀. The retrieval action 505 returns documents 510 (or other information) that are relevant to the initial query Q₀. The adaptive planning system 100 checks 515 a stopping rule for the initial query Q₀. The stopping rule check 515 fails because the cumulative context does not include enough information to allow an LLM attempt to answer the initial query to be successful. The adaptive planning system 100 generates 520 a sub-question Q₁ which is a question relevant to answering initial query Qo, while also being less complex than initial query Q₀. The adaptive planning system 100 executes a retrieval action 525 for the sub-question Q₁. The retrieval action 525 returns documents 530 (or other information) that are relevant to the sub-question Q₁. The adaptive planning system 100 checks 535 a stopping rule for the sub-question Q₁. The stopping rule check 535 passes because, after the retrieval action 525, the cumulative context includes enough information to allow an LLM attempt to answer the sub-question Q₁ to be successful. The adaptive planning system 100 therefore produces (using the LLM) an answer 540 to the sub-question Q₁. The adaptive planning system 100 provides 545 the answer 540 to the LLM as context for a further attempt to answer initial query Q₀. Once again, the adaptive planning system 100 checks 550 the stopping rule for the initial query Q₀. This time, the stopping rule check 550 passes because there is enough information to answer the initial query Q₀ in view of the added context from answer 540. The adaptive planning system 100 therefore produces (using the LLM) an answer 555 to initial query Q₀. The iterative, recursive nature of the adaptive planning technique is visible in the repetition of the steps for progressively simpler queries until valid answers are reached, and used to provide context for answering more complex queries.

Another example of a possible execution of the adaptive planner includes a math action, in which an equation that is relevant to the question is generated and evaluated. FIG. 6 illustrates, in a recursion tree diagram, an example adaptive planning analysis with math 600 that is associated with adaptive planning using LLMs. Analysis with math 600 operates with steps similar to those of example adaptive planning analysis 400, and further includes math actions 605, 610 in addition to retrieval actions 615, 620. In the math actions, an equation is generated and populated based on the question. The equation is evaluated with an interpreter (e.g., python) to produce mathematical information that is relevant to the question. The mathematical information is used, along with information obtained by the retrieval actions 615, 620, to answer the questions, and to determine whether the questions are being successfully answered.

While previous approaches have focused on executing step-by-step plans, the adaptive planner shown and described herein stands out due to its recursive and adaptive structure. Unlike previous approaches, the ability of the adaptive planner to recursively simplify tasks enables it to tackle knowledge-intensive challenges more effectively.

Additionally, adaptive planner shown and described herein innovatively incorporates a technique from uncertainty quantification—consistency-based checks-to determine when to stop execution. In contrast, other methods either fix the number of steps or allow the LLM to decide when to stop (e.g., by having ‘stop execution’ as an action).

The adaptive planner shown and described herein is also different from approaches such as Tree of Thoughts and Atom of Thoughts, as these approaches focus on extending the chain of thought of the LLM. They do not consider the use of actions, instead only adding structure to the thought step of the LLM, allowing them to be used in place of a chain of thought. Moreover, while Tree of Thoughts builds a tree of possible steps, only one root-to-leaf path is ultimately used. In contrast, the adaptive planner shown and described herein exploits all the information found in the recursive tree structure.

Advantageously, the adaptive planner shown and described herein improves over previous solutions that either relied on an entirely iterative structure or used a non-adaptive task-decomposition component. The adaptive planner is particularly effective for more complex tasks, as it dynamically generates simpler sub-questions when needed. At the same time, it remains efficient for simpler tasks, where it can stop after just a few iterations.

To prevent infinite execution, limits may be imposed on the number of questions that can be generated. As a result, the adaptive planner may include several hyperparameters for tuning: a maximum depth of the generated tree (i.e., the number of sub-questions recursively generated), a maximum width of the tree (i.e., the number of different sub-questions that can be generated for each question). Another hyperparameter to tune is the number of actions to perform before checking the stopping rule.

In one embodiment, the adaptive planning algorithm takes as input a question q, hyper-parameters max_width, max_depth, num_actions that specify the maximum number of questions and actions that adaptive planner can generate, and a set of actions/tools that can be used. Examples of actions include a retrieval step, where relevant information is retrieved from a set of documents, or a math step, where an equation is generated and evaluated to support the large language model's analysis.

Pseudo-code detailing one example of how the adaptive planning algorithm works is given in Table 1 below:

TABLE 1
Algorithm 1 AdaptivePlanner

| | |
|---|---|
| 01: | Input: Question q, max_width, max_depth, num_actions, set of actions A, LLM |
| 02: | Output: Answer answer |
| 03: | context:=“” |
| 04: | for idx = 1 to num_actions do |
| 05: | Pick an action a ∈ A using the LLM |
| 06: | Execute A (using the LLM if needed), and append the result to context |
| 07: | end for |
| 08: | cur_width := 0 |
| 09: | while cur_width < max_width AND max_depth > 1 AND NOT Stopping Rule(q, context) |
| | do |
| 10: | cur_width = cur_width + 1 |
| 11: | Generate a sub question q_{sub} using the LLM |
| 12: | Recursively solve q_{sub}: answer_{sub}, context_{sub} = AdaptivePlanner(q_{sub}, max_width − 1, |
| | max_depth − 1, num_actions − 1, A, LLM) |
| 13: | Append q_{sub}, answer_{sub}, and context_{sub}, to context |
| 14: | end while |
| 15: | Answer q with the LLM using context as supporting documents to obtain answer |
| 16: | Return answer and context |

Algorithm 2 StoppingRule

| | |
|---|---|
| 01: | Input: Question q, context, LLM |
| 02: | Output: Boolean that is True if the model has enough information to answer q, and False |
| | otherwise |
| 03: | Sample independently two answers for q and context from the LLM |
| 04: | if the answers are consistent and relevant to the question then |
| 05: | return True |
| 06: | else |
| 07: | return False |
| 08: | end if |

Prototype embodiments of the adaptive planning algorithm have been implemented and tested on several open-source benchmarks, for example as discussed below with reference to FIG. 7.

Picking an action is performed through an LLM call. In the LLM call, the adaptive planning system gives the LLM a description of the possible actions along with the current question and context and asks the LLM to choose one of the actions (e.g., retrieval, math).

Generating a sub-question is done by giving the LLM the current question and context and asking the LLM to come up with a sub-question that focuses on required information that is missing from the context. An example of a prompt to generate a sub-question is given in Table 2 below:

TABLE 2
Prompt for Sub-Question Generation

```
Given a question and some supporting documents, your task is to come up with
a new and simpler sub-question that is necessary to answer before dealing with
the main question. The sub-question should focus on finding information that is
NOT already present in the supporting documents, which can include previous
sub-questions with their answers. It should also be self-contained.
Think step-by-step using at most {{max_tokens}} tokens before generating the
sub-question.
Your output must end with one line with the following format:
  Subquestion: subquestion
  {{few_shot_examples}}
Now process the following question.
  Question: {{question}}
  Supporting documents: {{context}}
```

Once enough information is retrieved, the LLM answers the question using, for example, the following prompt given in Table 3:

TABLE 3
Prompt for Question Answering

```
You are given a question and some potentially useful documents. Your task is
to answer the question after thinking step-by-step using at most {{max_tokens}}
tokens. Write your answer on a new line that starts with ‘The answer is:’.
  {{few_shot_examples}}
Now answer the following question.
  Documents: {{context}}
  Question: {{question}}
```

Each component uses its own few-shot examples, so generating a sub-question and answering a question employs different examples.

### —Experimentation—

Datasets-In experimentation, four multi-hop Question-Answering datasets were used for the experiments: FinQA, MultiHop, MuSiQue, and a harder, more challenging version of the MuSiQue dataset, MuSiQue_Hard. The questions in these datasets require reasoning across multiple documents to find the answer.

In experimentation, the planner is provided with two actions: (1) A retrieval action which consists of generating a retrieval query, retrieving the k most similar chunks from a dataset, then summarizing the result using an LLM by focusing on information relevant to the query (if there is no useful information, the model returns “No information was found”). (2) A math action which consists of generating an equation that is then evaluated by a Python interpreter. Note that the math action was only used in the FinQA dataset, as it is the only dataset that involves reasoning over numerical data.

Baselines-Referring now to FIG. 7, FIG. 7 illustrates result graphs 700 of benchmarking tests of an example adaptive planning system. The performance of various algorithms described below-Direct Prompt, Direct Prompt with Chain-of-Thought (COT), Retrieval Augmented Generation (RAG), Iterative Plan, and Task Division Plan—is evaluated on questions for the above datasets as baselines for comparison for the performance of the adaptive planning algorithm. Performance is measured in out-of-sample accuracy vs. token count. This performance data is plotted against an accuracy axis and log tokens axis for each of the graphs. Performance of the various algorithms on the MuSiQue dataset are plotted in graph 705. Performance of the various algorithms on the MultiHop dataset are plotted in graph 710. Performance of the various algorithms on the MuSiQue (hard) dataset are plotted in graph 715. Performance of the various algorithms on the FinQA dataset are plotted in graph 720.

Direct Prompt: The LLM directly answers the question.

Direct Prompt with CoT: The LLM answers the question with Chain-of-Thought (i.e., after explaining its reasoning).

RAG: k chunks that are the most similar to the query are first retrieved as context, then summarized to only keep information relevant to the query. Then, the LLM uses CoT to answer the question given the context as supporting documents.

Iterative Plan: Iteratively execute an action, which can be a retrieval step or a math step. After T actions, the LLM answers the question given all the obtained context.

Task Division Plan: The main question is first divided into sub-questions that are then solved independently with iterative Plan. The results are then combined to solve the main question.

For the FinQA dataset, direct prompting is not used since the questions require a context to be answered (e.g., “What is the growth rate in the net income from 2007 to 2008?” cannot be answered without additional context).

Few-shot Examples and Hyperparameters—The benchmark testing procedure begins by splitting each dataset into three subsets: training, validation, and test, each containing 100 questions. The training set is used to generate few-shot examples for in-context learning, while the validation set is employed for hyperparameter tuning.

In the test, three few-shot examples are used for each algorithm component, and the following (tuned) hyperparameters:

For FinQA, Musique and MultiHop, Iterative RAG and task division use T=3 iterations while the adaptive planner uses max_depth=2, max_width=2 and num_actions=3.

For Musique_hard, Iterative RAG and task division use T=4 iterations while the adaptive planner uses max_depth=3, max_width=3 and num_actions=3.

The temperature of the LLM is set to 0 for all parts of the algorithms, except for the stopping rule, where the temperature is set to 0.5.

Results—The benchmarking results (shown in result graphs 700) show the out-of-sample accuracy versus total (input and output) token expenditure for each algorithm, generating two answers per question and reporting the standard errors of the accuracy.

Takeaways—the baselines which call the LLM once (direct prompt, direct prompt+CoT and RAG) have a significantly lower accuracy compared to other approaches. Hence multistep algorithms are necessary to deal with complex questions.

The adaptive planner (shown and described herein) is consistently the most accurate, even though it may use more tokens than an iterative approach.

While there is a trade-off between cost and accuracy, the adaptive planner remains more efficient than the task division algorithm as it adapts to the complexity of the question. Thus, in one embodiment, the adaptive planning system demonstrably improves over earlier techniques (direct prompt, direct prompt+chain-of-thought, retrieval augmented generation, iterative planning, and task division planning) for resolving questions that need reasoning across multiple documents to resolve.

End-to-End Example—An end-to-end example operation of the adaptive planning system is given in Table 4, below. Below is a question taken from the MuSiQue dataset and solved using the adaptive planner with num_actions=2. The relevant information of a retrieval query is the LLM query-focused summary of the corresponding retrieved documents.

```
TABLE 4
Q: When did the city where Souvenir's performer was born become the
capital of the state Knowles was from?
(1) * Retrieval Query 1: When did the city where Souvenir's performer was born
become the capital of the state Knowles was from? Relevant Information 1: No
information was found
(2) * Retrieval Query 2: What is the city where Souvenir's performer was born,
and what is the state that Knowles was from, and when did that city become the
capital of that state? Relevant Information 2: No information was found
(3) ? Not enough information was gathered to answer the question
  (4) Q1: What is the city where Souvenir's performer was born?
  (5) * Retrieval Query 1: What is the city where Souvenir's performer
  was born? Relevant Information 1: Souvenir is an album by Eric
  Johnson released in 2002.
  (6) * Retrieval Query 2: What is the city where Eric Johnson, the
  performer of the album Souvenir, was born? Relevant Information
  2: Eric Johnson, the performer of the album Souvenir, was born in
  Austin, Texas.
  (7) ! Q1 answer: Austin
(8) ? Not enough information was gathered to answer the question
  (9) Q2: What state is Knowles from?
  (10) * Retrieval Query 1: What state is Knowles from? Relevant
  Information: Beyoncé Giselle Knowles-Carter was born in Houston,
  Texas.
  (11) * Retrieval Query 2: Is Knowles from Houston, Texas? Relevant
  Information: Yes, Beyoncé Giselle Knowles-Carter was born in
  Houston, Texas.
  (12) ! Q2 answer: Texas
(13) ! Q answer: 1839
```

A recursion tree diagram 800 corresponding to the execution described in Table 4 is presented in FIG. 8. The steps numbered 1-13 in Table 4 above are shown in the recursion tree diagram 800 by step indicators correspondingly numbered 1-13 (ref. nos. 801-813).

### Example Advantages

Thus, in one embodiment, the adaptive planning system transforms uncontrolled, text-only LLM inference into a quantitatively governed computational process that manages context, recursion, and convergence in embedding space-thereby improving the efficiency, stability, accuracy, and predictability of machine reasoning performed by large-language-model systems.

In one embodiment, the adaptive planning system exhibits improved precision of information Each recursion adds new information that corresponds to gaps in the available information, minimizing redundant retrievals.

In one embodiment, the adaptive planning system exhibits improved efficiency: exhaustive exploration of all possible sub-topics is avoided, such that the system pursues just those sub-topics thar will fill specific information gaps.

In one embodiment, the adaptive planning system exhibits improved adaptability to task domains. The system works across a wide variety of tasks (financial QA, multi-hop reasoning, code generation) because “missing information” is inferred dynamically from detected inconsistency among proposed answers, and not from domain-specific knowledge.

In one embodiment, the adaptive planning system exhibits improved reliability. By ensuring that every recursion targets a concrete unknown, the adaptive planner converges faster and uses fewer tokens than exhaustive reasoning trees.

Conventional LLM systems lack a mechanism to detect information insufficiency during inference, causing unstable or divergent outputs. In one embodiment, the adaptive planning system introduces an LLM-driven feedback recursion to detect and correct incomplete contextual states using the LLM, thereby improving over the inability of conventional system to detect insufficiency of information during inference.

Existing LLM pipelines use a fixed or user-defined number of reasoning steps, leading to wasted computation and unpredictable latency. In one embodiment, at inference time, the adaptive planning system applies a dynamically-computed stopping rule based on information sufficiency, enabling adaptive termination that improves computational efficiency and resource allocation.

Retrieval-augmented generation architectures cannot adjust retrieval scope in response to intermediate reasoning failures. In one embodiment, the adaptive planning system expands the context buffer based on detected gaps in the information needed for answering a question, producing a self-modulating retrieval process that conserves bandwidth and token use.

Existing architectures rely on linear or breadth-first reasoning paths that scale poorly in token cost and compute load. In one embodiment, the adaptive planning system improves over these prior architectures by applying bounded, depth-controlled recursion governed by hyperparameters, which place deterministic limits on complexity while maintaining reasoning depth.

Existing LLM workflows lack a workable criterion for adaptively controlling the scale of multi-step LLM reasoning. In one embodiment, the adaptive planning system improves over these existing LLM workflows by applying a simple “yes” or “no” determination of information sufficiency by the LLM itself for automated control of recursive steps of LLM reasoning.

Conventional systems cannot unify text-based and numerical reasoning operations within a single adaptive control loop. In one embodiment of the adaptive planning system, a math module and a retrieval module share a uniform interface for expanding context, an improvement allowing integrated multimodal reasoning without external orchestration.

Static context accumulation causes redundant data storage and unbounded memory growth in iterative reasoning systems. In one embodiment, the adaptive planning system improves over this static context accumulation by maintaining a context buffer with controlled, cumulative updates that preserve information across recursion levels while enforcing bounded storage by depth and width limits.

Existing iterative planning frameworks cannot guarantee termination under recursive execution, risking infinite reasoning loops. In one embodiment, the adaptive planning system enforces deterministic termination through tunable hyperparameters for maximum recursion depth and width, verified at runtime by explicit counters.

### Cloud or Enterprise Embodiments

In one embodiment, the present system (such as adaptive planning system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, adaptive planning system 100 is a centralized server-side application that provides at least the functions disclosed herein and that is accessed by many users by way of computing devices/terminals communicating with the computers of adaptive planning system 100 (functioning as one or more servers) over a computer network. In one embodiment adaptive planning system 100 may be implemented by a server or other computing device configured with hardware and software to implement the functions and features described herein.

In one embodiment, the components of adaptive planning system 100 may be implemented as sets of one or more software modules executed by one or more computing devices specially configured for such execution. In one embodiment, the components of adaptive planning system 100 are implemented on one or more hardware computing devices or hosts interconnected by a data network. For example, the components of adaptive planning system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of adaptive planning system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of adaptive planning system 100 may (i) generate or compose an electronic message or signal to issue a command or request to another component, (ii) transmit the message or signal to other components of adaptive planning system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by adaptive planning system 100, for example through a web interface server. In one embodiment, the remote computing system may send requests to and receive responses from adaptive planning system 100. In one example, access to the information or applications may be effected through use of a web browser on a personal computer or mobile device. In one example, communications exchanged with adaptive planning system 100 may take the form of remote representational state transfer (REST) requests using JavaScript object notation (JSON) as the data interchange format for example, or simple object access protocol (SOAP) requests to and from XML servers. The REST or SOAP requests may include API calls to components of adaptive planning system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

In one embodiment, adaptive planning systems and methods described herein may be implemented by using a computer program product, comprising computer program/instructions which, when executed by a processor, cause the processor to perform any of the methods described in the disclosure.

### Computing Device Embodiment

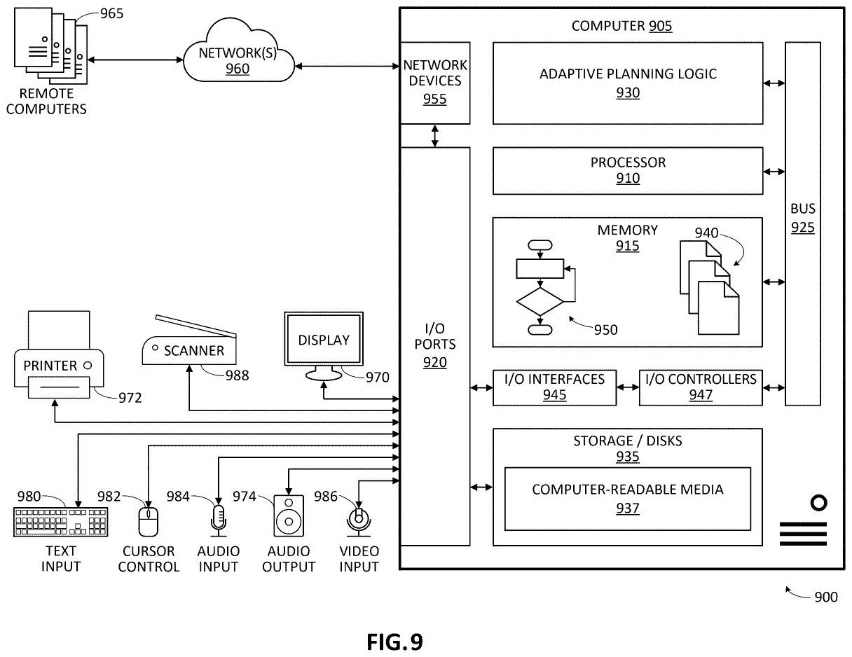

FIG. 9 illustrates an example computing system 900 that is configured and/or programmed as a special purpose computing device(s) with one or more of the example systems and methods described herein, and/or equivalents. The example computing device may be a computer 905 that includes at least one hardware processor 910, a memory 915, and input/output ports 920 operably connected by a bus 925. In one example, the computer 905 may include adaptive planning logic 930 configured to facilitate adaptive planning using LLMs, similar to logic, systems, methods, and other embodiments, shown in and described with reference to FIGS. 1-6.

In different examples, the logic 930 may be implemented in hardware, one or more non-transitory computer-readable media 937 with stored instructions, firmware, and/or combinations thereof. While the logic 930 is illustrated as a hardware component attached to the bus 925, it is to be appreciated that in other embodiments, the logic 930 could be implemented in the processor 910, stored in memory 915, or stored in disk 935.

In one embodiment, logic 930 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate adaptive planning using LLMs. The means may also be implemented as stored computer executable instructions that are presented to computer 905 as data 940 that are temporarily stored in memory 915 and then executed by processor 910.

Logic 930 may also provide means (e.g., hardware, non-transitory computer-readable medium that stores executable instructions, firmware) for performing one or more of the disclosed functions and/or combinations of the functions.

Generally describing an example configuration of the computer 905, the processor 910 may be a variety of various processors including dual microprocessor and other multi-processor architectures. A memory 915 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 935 may be operably connected to the computer 905 via, for example, an input/output (I/O) interface (e.g., card, device) 945 and an input/output port 920 that are controlled by at least an input/output (I/O) controller 947. The disk 935 may be, for example, a magnetic disk drive, a solid-state drive, a floppy disk drive, a tape drive, a Zip drive, a flash memory card, a memory stick, and so on. Furthermore, the disk 935 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 915 can store a process 950 and/or a data 940, for example. The disk 935 and/or the memory 915 can store an operating system that controls and allocates resources of the computer 905.

The computer 905 may interact with, control, and/or be controlled by input/output (I/O) devices via the input/output (I/O) controller 947, the I/O interfaces 945, and the input/output ports 920. Input/output devices may include, for example, one or more network devices 955, displays 970, printers 972 (such as inkjet, laser, or 3D printers), audio output devices 974 (such as speakers or headphones), text input devices 980 (such as keyboards), cursor control devices 982 for pointing and selection inputs (such as mice, trackballs, touch screens, joysticks, pointing sticks, electronic styluses, electronic pen tablets), audio input devices 984 (such as microphones or external audio players), video input devices 986 (such as video and still cameras, or external video players), image scanners 988, video cards (not shown), disks 935, and so on. The input/output ports 920 may include, for example, serial ports, parallel ports, and USB ports.

The computer 905 can operate in a network environment and thus may be connected to the network devices 955 via the I/O interfaces 945, and/or the I/O ports 920. Through the network devices 955, the computer 905 may interact with a network 960. Through the network 960, the computer 905 may be logically connected to remote computers 965. Networks with which the computer 905 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which one or more communication channels are established (or may be established upon request) that allow signals, data messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
intercept, by a computing system, a digital representation of a question expressed in natural language presented for resolution by a large language model;
acquiring, by the computing system, digital information that is relevant to answering the question and absent from a digital context associated with the natural language question;
determining, by the computing system, that a gap exists in the acquired information based on an information sufficiency response by the large language model to an information sufficiency query to assess whether the acquired information is sufficient to answer the question;
generating, by the computing system, a sub-question in natural language that is formulated to request information that fills the gap in the acquired information; and
recursively executing, by the computing system, the computer-implemented method with the sub-question in place of the question until the gap in the acquired information is eliminated, thereby improving accuracy and efficiency of reasoning by the large language model by adaptively identifying and filling gaps in the acquired information.

2. The computer-implemented method of claim 1, wherein determining that the gap exists in the acquired information further comprises determining that the information sufficiency response indicates that the information is not sufficient, wherein the information sufficiency response is one of a plurality of information sufficiency responses, one or more of which may indicate that the information is sufficient.

3. The computer-implemented method of claim 1, wherein generating the sub-question further comprises assembling a prompt including the question, the digital context, an indication of missing information that is absent from the context, and an instruction to generate a sub-question that requests the missing information.

4. The computer-implemented method of claim 1, wherein the computing system executes the method subject to at least one of the following hyperparameters: a maximum recursion depth, a maximum number of sub-questions per recursion level, and a maximum number of information acquisition actions performed before determining whether the gap exists, the computer-implemented method further comprising tuning the at least one of the hyperparameters to maximize answer accuracy for a given token budget using a validation dataset.

5. The computer-implemented method of claim 1,
wherein the generating a sub-question in natural language further comprises generating a plurality of sub-questions up to a pre-set maximum, and
wherein the recursively executing the computer-implemented method with the sub-question in place of the question further includes recursively executing the plurality of sub questions.

6. The computer-implemented method of claim 1, wherein acquiring the information further comprises prompting the large language model to choose from among a set of actions for acquiring the information, wherein the prompt includes the question and context.

7. The computer-implemented method of claim 1, further comprising automatically terminating recursion upon satisfaction of a threshold for information sufficiency by the plurality of information sufficiency responses generated by the large language model.

8. A computing system, comprising:
at least one processor connected to at least one memory;
one or more non-transitory computer readable media having instructions stored thereon that when executed by at least the processor cause the computing system to execute steps of a computer-implemented method, comprising:
intercept a digital representation of a question expressed in natural language presented for resolution by a large language model;
acquire digital information that is relevant to answering the question and absent from a digital context associated with the natural language question;
determine that a gap exists in the acquired information based on an information sufficiency response by the large language model to an information sufficiency query to assess whether the acquired information is sufficient to answer the question;
generate a sub-question in natural language that is formulated to request information that fills the gap in the acquired information; and
recursively execute the computer-implemented method with the sub-question in place of the question until the gap in the acquired information is eliminated.

9. The computing system of claim 8, wherein the instructions to determine that a gap exists in the acquired information further cause the computing system to determine that the information sufficiency response indicates that the information is not sufficient, wherein the information sufficiency response is one of a plurality of information sufficiency responses, one or more of which may indicate that the information is sufficient.

10. The computing system of claim 8, wherein the instructions to generate the sub-question further causes the computing system to assemble a prompt including the question, the digital context, an indication of missing information that is absent from the context, and an instruction to generate a sub-question that requests the missing information.

11. The computing system of claim 8, wherein the instructions apply at least one of the following hyperparameters: a maximum recursion depth, a maximum number of sub-questions per recursion level, and a maximum number of information acquisition actions performed before determining whether the gap exists.

12. The computing system of claim 8,
wherein the instructions to generate a sub-question in natural language further cause the computing system to generate a plurality of sub-questions up to a pre-set maximum, and
wherein the instructions to recursively execute the computer-implemented method with the sub-question in place of the question further cause the computing system to recursively executing the plurality of sub questions.

13. The computing system of claim 8, wherein the instructions for acquiring the information further cause the computing system to at least one of: (a) extract the information from a document; or (b) evaluate an equation to generate the information.

14. The computing system of claim 8, wherein the instructions further cause the computing system to automatically terminate recursion upon each of a plurality of information sufficiency responses indicating that the information is sufficient to answer the question.

15. One or more non-transitory computer readable media having instructions stored thereon that when executed by at least a processor of a computing system cause the computing system to execute steps of a computer-implemented method, comprising:
intercept a digital representation of a question expressed in natural language presented for resolution by a large language model;
acquire digital information that is relevant to answering the question and absent from a digital context associated with the natural language question;
determine that a gap exists in the acquired information based on an information sufficiency response by the large language model to an information sufficiency query to assess whether the acquired information is sufficient to answer the question;
generate a sub-question in natural language that is formulated to request information that fills the gap in the acquired information; and
recursively execute the computer-implemented method with the sub-question in place of the question until the gap in the acquired information is eliminated.

16. The one or more non-transitory computer readable media of claim 15, wherein the instructions to determine that a gap exists in the acquired information further cause the computing system to determine that the information sufficiency response indicates that the information is not sufficient, wherein the information sufficiency response is one of a plurality of information sufficiency responses, one or more of which may indicate that the information is sufficient.

17. The one or more non-transitory computer readable media of claim 15, wherein the instructions to generate the sub-question further causes the computing system to assemble a prompt including the question, the digital context, an indication of missing information that is absent from the context, and an instruction to generate a sub-question that requests the missing information.

18. The one or more non-transitory computer readable media of claim 15, wherein the instructions apply at least one of the following hyperparameters: a maximum recursion depth, a maximum number of sub-questions per level of recursion, and a maximum number of information acquisition actions performed before determining whether the gap exists.

19. The one or more non-transitory computer readable media of claim 15,
wherein the instructions to generate a sub-question in natural language further cause the computing system to generate a plurality of sub-questions up to a pre-set maximum, and
wherein the instructions to recursively execute the computer-implemented method with the sub-question in place of the question further cause the computing system to recursively execute the plurality of sub questions.

20. The one or more non-transitory computer readable media of claim 15, wherein the instructions for acquiring the information further cause the computing system to:
generate a retrieval query using the large language model;
execute the retrieval query to extract text segments from a document corpus; and
summarize the extracted text segments using the large language model to produce the acquired information.
